(19) United States
(12) Patent Application Publication
(10) Pub. No.: US 2016/0336799 A1
(43) Pub. Date: Nov. 17, 2016

(54) COMMERCIAL AC POWER SHUTDOWN DETECTING APPARATUS, AND SYSTEM INCLUDING THE SAME

(71) Applicants: Atsuki Iwata, Tokyo (JP); Takuma Kasai, Kanagawa (JP); Norikazu Okada, Kanagawa (JP); Homare Ehara, Kanagawa (JP); Tetsuya Yano, Kanagawa (JP); Toshimasa Aoki, Kanagawa (JP); Tomoyuki Yamashita, Kanagawa (JP); Ryohta Kubokawa, Kanagawa (JP); Shuntaroh Nakayama, Kanagawa (JP); Takaaki Shirai, Tokyo (JP)

(72) Inventors: Atsuki Iwata, Tokyo (JP); Takuma Kasai, Kanagawa (JP); Norikazu Okada, Kanagawa (JP); Homare Ehara, Kanagawa (JP); Tetsuya Yano, Kanagawa (JP); Toshimasa Aoki, Kanagawa (JP); Tomoyuki Yamashita, Kanagawa (JP); Ryohta Kubokawa, Kanagawa (JP); Shuntaroh Nakayama, Kanagawa (JP); Takaaki Shirai, Tokyo (JP)

(73) Assignee: Ricoh Company, Ltd., Tokyo (JP)

(21) Appl. No.: 15/143,604

(22) Filed: May 1, 2016

(30) Foreign Application Priority Data
May 15, 2015 (JP) 2015100091

(51) Int. Cl. H02J 9/06; H04N 1/00; H02J 7/00

(52) U.S. Cl. CPC H02J 9/061; H02J 7/0068; H04N 1/00893; H04N 1/00899; H02J 7/345

(57) ABSTRACT

A commercial AC power shutdown detecting apparatus includes a photocoupler including a light-emitting element and a light-receiving element, a lighting circuit that flows a pulsating current through the light-emitting element of the photocoupler to turn on and off light of the light-emitting element, a charging-discharging circuit including a capacitor and a resistor that charges the capacitor via the resistor when the light-emitting element is turned off, and discharges the capacitor via the light-receiving element and the a resistor when the light-emitting element is turned on, and a comparing circuit that compares a voltage value between capacitor terminals with a predetermined voltage value intermediate between a maximum voltage value between the capacitor terminals when the light-emitting element repeats turning light on and off and the consistent DC voltage value, and outputs a shutdown detection signal if the voltage value between the capacitor terminals exceeds the predetermined voltage value.

### CROSS-REFERENCE TO RELATED APPLICATIONS

This patent application is based on and claims priority pursuant to 35 U.S.C. §119(a) to Japanese Patent Application No. 2015-100091, filed on May 15, 2015 in the Japan Patent Office, the entire disclosures of which are hereby incorporated by reference herein.

### BACKGROUND

1. Technical Field

The present invention relates to a commercial alternate current (AC) power shutdown detecting apparatus, and a system including the same.

2. Background Art

The devices and apparatuses that operate with power supplied from a commercial AC power source, may stop operating, as the commercial AC power supply shuts down accidently, for example, by a blackout or unplugging of a power connector. In view of this, a technology that detects the shutdown, switches to a backup power supply, and supplies power from the backup power supply to a module or a circuit for maintaining a minimum function of such devices or an apparatuses is known.

Regarding the technology that detects the shutdown of the commercial AC power, for example, a detection method that continuously detects an input voltage and determines that the commercial AC power is shut down if the detected voltage gets lower is known.

### SUMMARY

An example embodiment of the present invention provides a novel commercial AC power shutdown detecting apparatus that includes a photocoupler including a light emitting element and a light receiving element in a package, a lighting circuit that flows a pulsating current through the light emitting element of the photocoupler to turn on and off light of the light emitting element, the pulsating current being a full-wave rectified alternate current supplied from a commercial AC power, a charging-discharging circuit including a capacitor and at least one resistor, the charging-discharging circuit that charges the capacitor using a DC voltage supplied from a DC power supply via the at least one resistor when the light emitting element is turned off, and discharges the capacitor via the light receiving element and the at least one resistor when the light emitting element is turned on, and a comparing circuit that compares a voltage value between terminals of the capacitor with a predetermined voltage value intermediate between a maximum voltage value between the terminals of the capacitor when the light emitting element repeats turning light on and off and the consistent DC voltage value, and outputs a shutdown detection signal if the voltage value between the terminals of the capacitor exceeds the predetermined voltage value.

Further embodiments of the present invention provide a system including the same.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating a commercial AC power shutdown detecting apparatus as an embodiment of the present invention.

FIG. 2 is a timing chart illustrating waveforms of voltage when the commercial AC power is shut down at the time of tₐ after the commercial AC power is supplied to the commercial AC power shutdown detecting apparatus in FIG. 1 as an embodiment of the present invention.

FIG. 3 is a timing chart illustrating waveforms when the commercial AC power is recovered at the time of t_{b} at which a peak value of the AC voltage becomes almost maximum after the commercial AC power is shut down as an embodiment of the present invention.

FIG. 4 is a timing chart illustrating waveforms when the commercial AC power is recovered at the time of t_{c} near a zero-cross point of the AC voltage after the commercial AC power is shut down as an embodiment of the present invention.

FIG. 5 is a circuit diagram illustrating a system including the commercial AC power shutdown detecting apparatus as an embodiment of the present invention.

FIG. 6 is a circuit diagram illustrating another system including the commercial AC power shutdown detecting apparatus as an embodiment of the present invention.

FIG. 7 is a circuit diagram illustrating a part of an image forming apparatus including the commercial AC power shutdown detecting apparatus as an embodiment of the present invention.

The accompanying drawings are intended to depict example embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operate in a similar manner, and achieve a similar result.

A more complete appreciation of the disclosure and many of the attendant advantages thereof will be readily obtained as the same becomes better understood by reference to the following detailed description when considered in conjunction with the accompanying drawings.

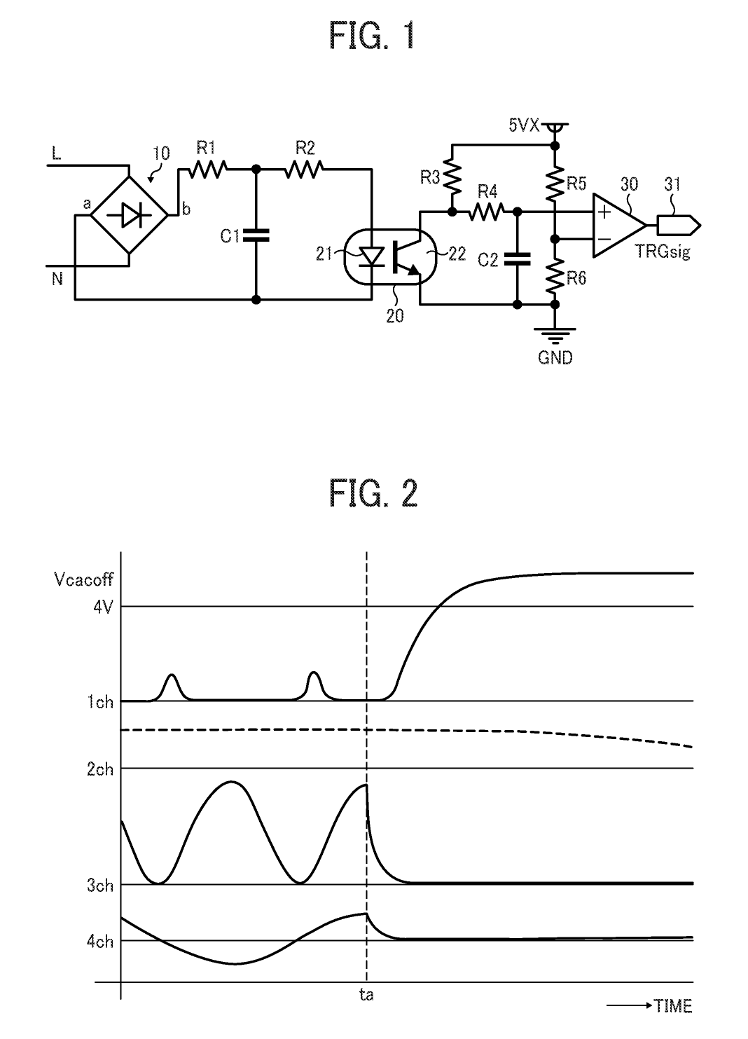

FIG. 1 is a diagram illustrating a commercial AC power shutdown detecting apparatus in this embodiment.

Referring to FIG. 1, a configuration of the commercial AC power detecting apparatus is described below along with a basic operation of the commercial AC power detecting apparatus.

A diode bridge 10, which operates as a full-wave rectifying circuit, applies full-wave rectification on the alternate current between power lines L and N, which is supplied from the commercial AC power. A current flows into a light emitting element 21 of a photo-coupler 20 from output terminals a and b of the diode bridge 10 via a series circuit including resistors R1 and R2 for controlling the current to repeat turning on and turning off.

The diode bridge 10 and the resistors R1 and R2 together function as a lighting circuit to flow a pulsating current, which is the full-wave rectified alternate current supplied from the commercial AC power, to the light emitting element 21 of the photo-coupler 20 to turn or off the light emitting element 21.

A capacitor C1 is connected between a connecting point of the resistors R1 and R2 and an output terminal a of the diode bridge 10 to eliminate noise.

The photocoupler 20 includes the light emitting element 21 and a light-sensitive element 22, which are provided in a package so as to isolate each other. If the light emitting element 21 is turned on (emitting light), the light-sensitive element 22 receives the light to become electrical continuity state (turned on). If the light emitting element 21 is turned off, the light-sensitive element 22 does not receive light to stay as non-electrical continuity state (turned off). The light emitting element 21 is generally a light emitting diode (LED), and the light-sensitive element 22 is generally a phototransistor.

At the side of the light-sensitive element 22 in the photocoupler 20, the light-sensitive element 22 is turned off such that current does not flow when the light emitting element 21 is turned off. In such case, a capacitor C2 is charged by a 5 VX power source via a serial circuit including resistors R3 and R4.

The 5 VX power source is a DC power source that supplies a constant DC voltage (i.e., 5 V in this case), and the 5 VX power source can be implemented by either a battery or an AC-DC power source that rectifies the alternate current and acquires a direct-current voltage.

If the light emitting element 21 of the photocoupler 20 is turned on (emitting light), the light-sensitive element 22 is turned on and the current flows through the light-sensitive element 22. Therefore, charging to the capacitor C2 stops, causing the capacitor C2 to discharge. That is because the current that flows through the resistor R3 output from the 5 VX power source is bypassed to a ground GND via the light-sensitive element 22 and the current that flows through the resistor R4 output from the capacitor C2 flows through the light-2 sensitive element 22 and is discharged to the ground GND.

A charging-discharging circuit is constructed by the light-sensitive element 22 of the photocoupler 20, the resistors R3 and R4, and the capacitor C2 connected with each other between the 5 VX power source and the ground GND. If the light emitting element 21 of the photocoupler 20 is turned off, the charging-discharging circuit charges the capacitor C2 using the consistent DC voltage (i.e., 5 V in this case) from the DC power source via the resistors R3 and R4. By contrast, if the light emitting element 21 of the photocoupler 20 is turned on, the charging-discharging circuit discharges the capacitor C2 via the light-sensitive element 22 and the resistor R4.

In charging the capacitor C2, the resistor R4 operates as a part of a charging resistor. By contrast, if the light emitting element 21 of the photocoupler 20 is turned on, the resistor R4 operates as a discharging resistor that discharges electrical charge stored in the capacitor C2. In addition, it is preferable to design the charging-discharging circuit to make a resistance value of the resistor R4 smaller than a resistance value of the resistor R3 so that the electrical charge in the capacitor C2 is discharged completely and a charging start voltage of the capacitor C2 becomes nearly zero by the next charging operation.

In this embodiment, by flowing the current through the light emitting element 21 of the photocoupler 20 and repeating turning on (emitting light) and off, the full-wave rectification is performed on the alternate current from the commercial AC power supply and the current is limited. However, it is possible to customize the charging-discharging circuit such that, after applying the full-wave rectification on the alternate current from the commercial AC power source via a current limiting resistor, the output current flows through the light emitting element 21.

In inputting the normal commercial AC power supply, the light emitting element 21 emits light almost always since the voltage with the pulsating waveform is applied to the light emitting element 21 of the photocoupler 20 after performing the full-wave rectification on the alternate current from the commercial AC power supply. The light emitting element 21 is turned off only within a short amount of time around the zero-cross point of the alternating current voltage of the commercial AC power supply.

As a result, the capacitor C2 is charged during such short time period when the light emitting element is turned off. However, the period of time when the light emitting element is turned on and turned off can be varied by modifying the resistance value of the resistors R1 and R2 and the voltage value of the commercial AC power supply etc. so that the period of time for turning on or off can be appropriately adjusted, to allow flexibility in circuit design.

Normally, in inputting the commercial AC power supply, the voltage between terminals of the capacitor C2 becomes maximum when it is started to discharge. Therefore, the circuit is designed so that the maximum voltage value V_{chst} becomes equal to or smaller than a half of 5 V, which is a constant DC voltage value of power supply from the 5 VX power source (e.g., around 1 to 2 volts).

If the commercial power supply is shut down, the light emitting element 21 of the photocoupler 20 is kept turned off continuously over the short time period described above, and the capacitor C2 is kept charged over the maximum voltage value V_{chst}.

To cope with this issue, a predetermined voltage value intermediate between the maximum voltage value V_{chst} described above and the consistent DC voltage value (5 V) is configured as a voltage value V_{cacoff} as a determination standard adequate to detection time required considering a charging characteristic of the capacitor C2. The voltage value V_{cacoff} as the determination standard is configured as 4 V for example by dividing the DC voltage value (5 V) from the 5 VX power source using the resistors R5 and R6 and input into a negative input terminal of a comparator 30.

On the other hand, the voltage between terminals of the capacitor C2 (charging voltage) is input into a positive input terminal of the comparator 30.

In the commercial AC power shutdown detecting apparatus configured as described above, in inputting the commercial power, charging the capacitor C2 and discharging the capacitor C2 is repeated within a voltage range of 0 to V_{chst} for the voltage between terminals.

If the commercial power is shut down, it is stopped to discharge the capacitor C2 at that time, and the capacitor C2 is only charged. Therefore, the voltage between terminals of the capacitor C2 becomes larger than the voltage value V_{cacoff} as the determination standard. Subsequently, an output of the comparator 30 is inverted, and a shutdown detection signal TRG_{sig} is generated. After that, the shutdown detection signal TRG_{sig} is output from a signal output terminal 31, to report exteriorly that the commercial power is shut down.

A comparing circuit is constructed by a voltage dividing circuit including the resistors R5 and R6 generating the voltage value V_{cacoff} as the determination standard, and that is serially connected between the 5 VX power source and the ground GND, and the comparator 30. The comparing circuit compares the voltage value between the terminals of the capacitor C2 with the voltage value V_{cacoff} as the determination standard, and outputs a shutdown detection signal TRG_{sig} if the voltage value between the terminals of the capacitor C2 becomes larger than the voltage value V_{cacoff}.

The voltage value V_{cacoff} as the determination standard is a predetermined voltage value between the maximum voltage value V_{chst} of between the terminals of the capacitor C2 and the consistent DC voltage value (5 V), which is obtained when turning on and off of the light emitting element 21 is repeated.

Even if the 5 VX power source is generated using the AC-DC power supply, it is possible to detect that the commercial power is shut down since the 5 VX power source is not turned off just after the commercial power is shut down. If the 5 VX power source using the AC-DC power is used, it is preferable to design the AC-DC power supply so that the output voltage of the 5 VX power source is maintained sufficiently longer than the time detecting that the commercial power is shut down

FIGS. 2 to 4 are diagrams illustrating waveforms to describe an operation of the commercial AC power shutdown detecting apparatus, and those diagrams are drawn by operating the commercial AC power shutdown detecting apparatus with the configuration described above to confirm actual waveforms.

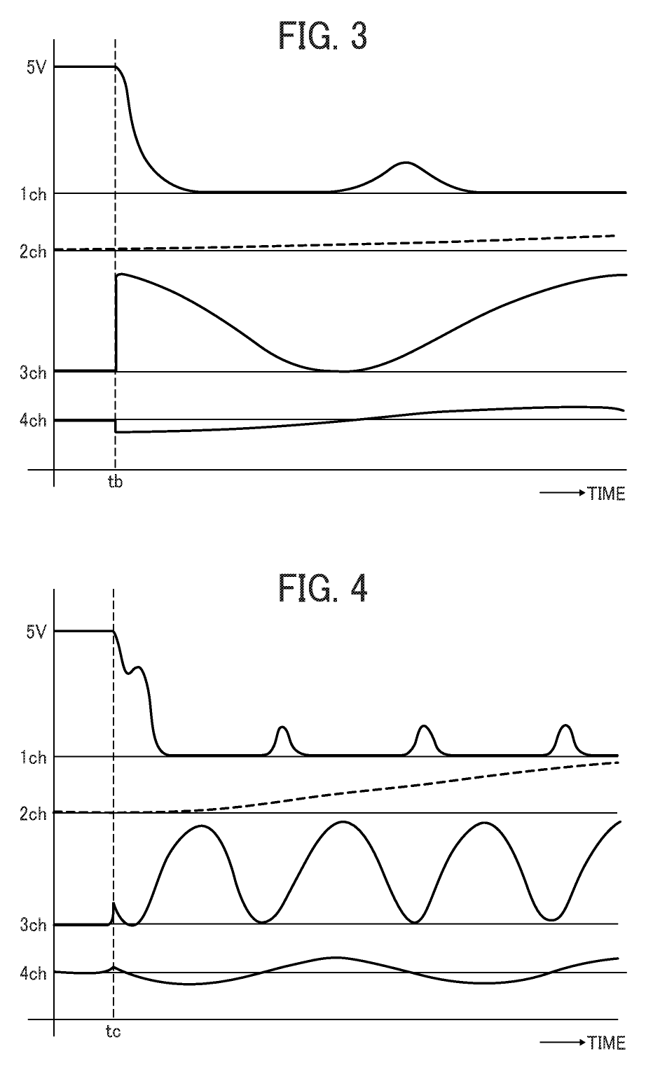

In FIGS. 2 to 4, waveforms 1 ch to 4 ch indicate waveforms described below respectively. In addition, while timescales of FIGS. 2 and 4 are the same, a timescale of FIG. 3 is magnified four times compared to the timescales of FIGS. 2 and 4.

1 ch is a waveform between the terminals of the capacitor C2 in FIG. 1 (i.e., the charging voltage, a voltage value of the positive input terminal of the comparator 30). 2 ch is a referential waveform of a voltage signal in case of detecting the commercial AC power shutdown using the known method. 3 ch is a referential waveform of performing the full-wave rectification on alternating current voltage in a same power supply system. 4 ch is a referential waveform of resistor load current in a same power supply system.

FIG. 2 is a diagram illustrating waveforms of voltage when the commercial AC power is shut down at the time of tₐ after inputting the commercial AC power in this embodiment.

According to the waveform of 1 ch in FIG. 2, since the commercial AC power is input during two cycles in the first half, charging the capacitor C2 and discharging the capacitor C2 are repeated in a voltage range of 0 to V_{chst} as the voltage value between the terminals (nearly 1 V).

After the commercial AC power is shut down at the time of tₐ on the time base, it is stopped to charge the capacitor C2 and started to charge the capacitor C2. It takes about 4 ms until the voltage value between the terminals becomes the voltage value V_{cacoff} as the determination standard after starting charging (e.g., 4 V). That fact indicates that it is possible to detect that the commercial AC power is shut down quickly enough.

As a result, it is possible to detect the shutdown in about 4 ms, that is, one fifth of a period 20 ms of the alternating current voltage of the commercial AC power. In the voltage signal waveform shown in 2 ch with broken lines for reference adopting the known method, since the voltage value varies just slightly within 4 ms or so, it is difficult to detect the shutdown of the commercial AC power without fault.

The referential waveform is a voltage signal waveform of direct-current voltage adopting a method rectifying and smoothing the alternating current voltage of the commercial AC power to convert into direct-current voltage and detects the shutdown of the commercial AC power based on variation of the direct-current voltage.

In case of using this known method described above, the input alternating current voltage is converted into the direct-current voltage, thus resulting in late response since it takes time to vary the direct-current voltage after the commercial AC power is shut down.

FIG. 3 is a diagram illustrating waveforms when the commercial AC power is recovered at the time of t_{b} (i.e., the AC input is restarted) when a peak value of the AC voltage becomes almost maximum after the commercial AC power is shut down in this embodiment.

According to the waveform of 1 ch in FIG. 3, it takes 0.453 ms until the voltage value between the terminals of the capacitor C2 becomes zero from the voltage value of the 5 VX power source (5 V) after starting discharging due to the recovery of the commercial AC power. Therefore, it is possible to detect shut down of the commercial AC power after that time when the voltage value between the terminals of the capacitor C2 becomes zero. As a result, it shows that the recovery time of the detection circuit in the commercial AC power shutdown detecting apparatus is short enough.

In the voltage signal waveform shown in 2 ch with broken lines for reference adopting the known method, the alternating current voltage is rectified and smoothed even after the commercial power recovers. Therefore, it takes time until the voltage signal reaches a normal voltage value, and it takes relatively long time to recover the detection circuit.

FIG. 4 is a diagram illustrating waveforms when the commercial AC power is recovered at the time of t_{c} near a zero-cross point of the AC voltage (i.e., the AC input is restarted) after the commercial AC power is shut down in this embodiment.

If the signal reaches the zero-cross point just after the commercial AC power is recovered, as shown in a waveform of 1 ch in FIG. 4, the voltage between the terminals of the capacitor C2 rises from the voltage value of the 5 VX power source (5 V) because it is charged temporarily just after starting discharging due to the recovery of the commercial power. However, the capacitor C starts discharging again right after, and the voltage value between terminals of the capacitor C2 becomes 0 V in a short period of time.

In this case, since the charging time and the charging voltage around the timing of the zero-cross point is added to the discharge of the capacitor C2, it takes about 2.6 ms to recover the detection circuit of the commercial AC power shutdown detecting apparatus. This is much less than 5 ms, which is a time period until the next charging operation takes place.

After the electrical charge in the capacitor C2 is completely discharged, charging and discharging is repeated by the operation of the photocoupler 20 using the input of the commercial AC power, and it is possible to detect that the commercial AC power is shut down.

As shown in FIG. 1, the circuit configuration of the commercial AC power shutdown detecting apparatus is simple and less expensive. Further, the commercial AC power shutdown detecting apparatus is able to detect shut down of the commercial AC power in a short period of time. This allows to quickly switch to the backup power supply as the commercial AC power is shut down.

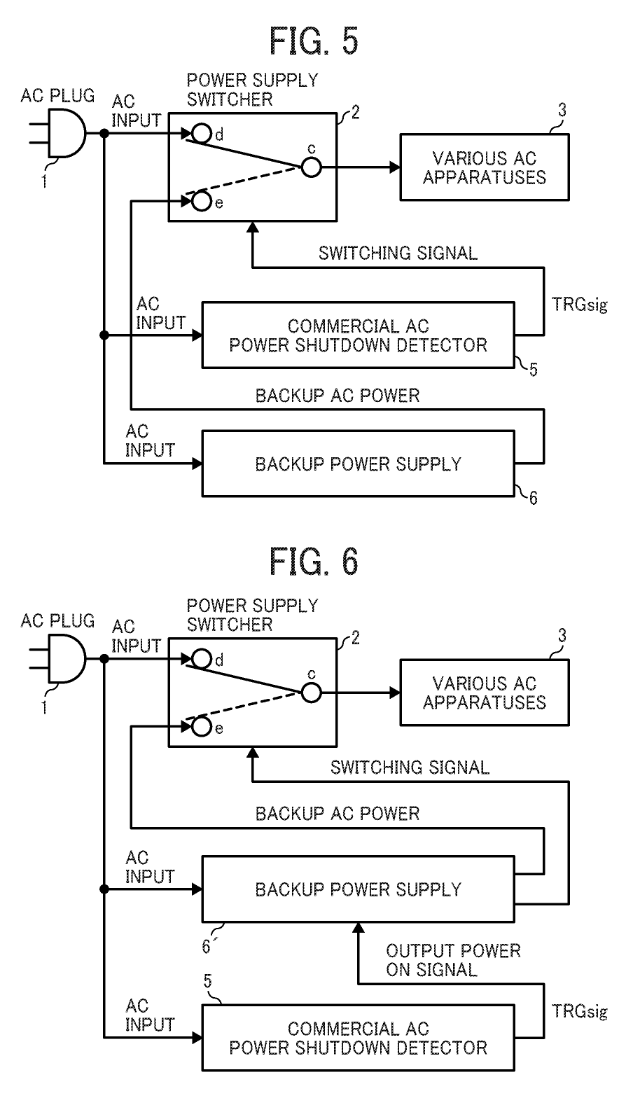

FIG. 5 is a block diagram illustrating a system including the commercial AC power shutdown detecting apparatus in this embodiment.

The apparatus system in FIG. 5 includes an AC plug 1, a power supply switcher 2, various AC apparatuses 3 as various loads, the commercial AC power shutdown detecting apparatus 5 in this embodiment described above, and a backup power supply 6.

In the apparatus system, the AC plug 1 plugged into an AC outlet of the commercial AC power is connected to various AC apparatuses via the power supply switcher 2. The power supply switcher 2 operates as shown in FIG. 5 with solid lines normally. As a result, the alternating current power of the commercial AC power is supplied to various AC apparatuses 3 from the AC plug 1 via terminals d and c. Under control of an external switching signal, the power supply switcher 2 can switch power so that power from the backup power supply 6 is supplied to the various AC apparatuses via terminals e and c.

The AC input from the AC plug 1 is supplied to the commercial AC power shutdown detecting apparatus 5 and the backup power supply 6. As described above, the commercial AC power shutdown detecting apparatus 5 outputs the shutdown detection signal TRG_{sig} when it is detected that the commercial AC power is shut down. By inputting the shutdown detection signal TRG_{sig} as the external switching signal into the power supply switcher 2, it is possible to switch the power supply switcher 2 as shown in FIG. 5 with broken lines so that the alternating current power from the backup power supply 6 is supplied to various AC apparatuses when the commercial AC power is shut down.

As the power supply switcher 2, it is possible to use various devices such as a relay, latching relay, and semiconductor switching element etc. in accordance with usage.

In the backup power supply 6, the DC power rectifying the AC input from the commercial AC power is charged in a charging circuit such as a secondary battery etc. If the AC power is shut down, the charged DC power is converted to backup AC power just like the AC power from the commercial AC power and output externally. For example, the backup power supply 6 is the UPS and used as the backup power supply when the commercial AC power is shut down. An output terminal of the backup power supply 6 is connected to the input terminal e of the power supply switcher 2.

In the apparatus system in this embodiment, if the commercial AC power is shut down, the commercial AC power shutdown detecting apparatus 5 detects the shutdown promptly and outputs the shutdown detection signal TRG_{sig} to the power supply switcher 2. As a result, the power supply switcher 2 switches the power supply line, such as from the solid line to the broken line in FIG. 5, to supply the backup power from the backup power supply 6 to the various AC apparatuses 3.

Therefore, even after the commercial AC power is shut down, it is possible to prevent the power source from going down and supply the backup AC power from the backup power supply 6 to the various AC apparatuses 3 for a certain period of time. To extend the period of time that the power can be supplied, it is preferable that the backup power supply 6 supplies power only to specific parts such as modules and circuits etc. for maintaining basic operations and functions among various AC apparatuses 3 as various loads.

After the commercial AC power is recovered and the alternate current power is input from the AC plug 1 again, the commercial AC power shutdown detecting apparatus 5 stops outputting the shutdown detection signal TRG_{sig} immediately. As a result, the power supply switcher 2 is switched the power supply line, that is, to the original solid line in FIG. 5, and the apparatus system goes back to the normal operation that the alternate current power from the AC plug 1 is supplied to the various AC apparatuses 3.

FIG. 6 is a block diagram illustrating another apparatus system including the commercial AC power shutdown detecting apparatus in another embodiment. In this embodiment, only difference from the embodiment described above shown in FIG. 5 is that the switching signal for switching the power supply switcher 2 is generated by the backup power supply 6.

In this apparatus system, when the commercial AC power is shut down, the commercial AC power shutdown detecting apparatus 5 detects the shutdown promptly and outputs the shutdown detection signal TRG_{sig}. However, in this embodiment, the shutdown detection signal TRG_{sig} is input not to the power supply switcher 2 but to the backup power supply 6 as an output power on signal.

As a result, the switching signal is output to the power supply switcher 2 at the same time as the backup power supply 6 can output the alternate current power. Consequently, the power supply switcher 2 is switched from the normal status as indicated by the solid line to the status as indicated by the broken line to supply the backup AC power from the backup power supply 6 to the various AC apparatuses 3 via the terminals e and c.

By adopting the configuration described above, in comparison with the embodiment shown in FIG. 5, since the backup power supply 6 outputs the AC power only when the commercial AC power is shut down, this system is superior in energy-saving.

That is, in the configuration shown in FIG. 5, the backup power supply 6 such as the UPS always converts the stored DC power into the AC power to output the AC power. However, in the configuration shown in FIG. 6, the stored DC power is converted to the AC power only when the commercial AC power shutdown detecting apparatus 5 detects that the commercial AC power is shut down after the commercial AC power is shut down and supplies power from the backup power supply 6 to the various AC apparatuses 3. This saves more energy.

Any one of the above-described systems may be implemented by an image forming apparatus capable of forming an image, such as a printer, copier, and multifunction peripheral (MFP).

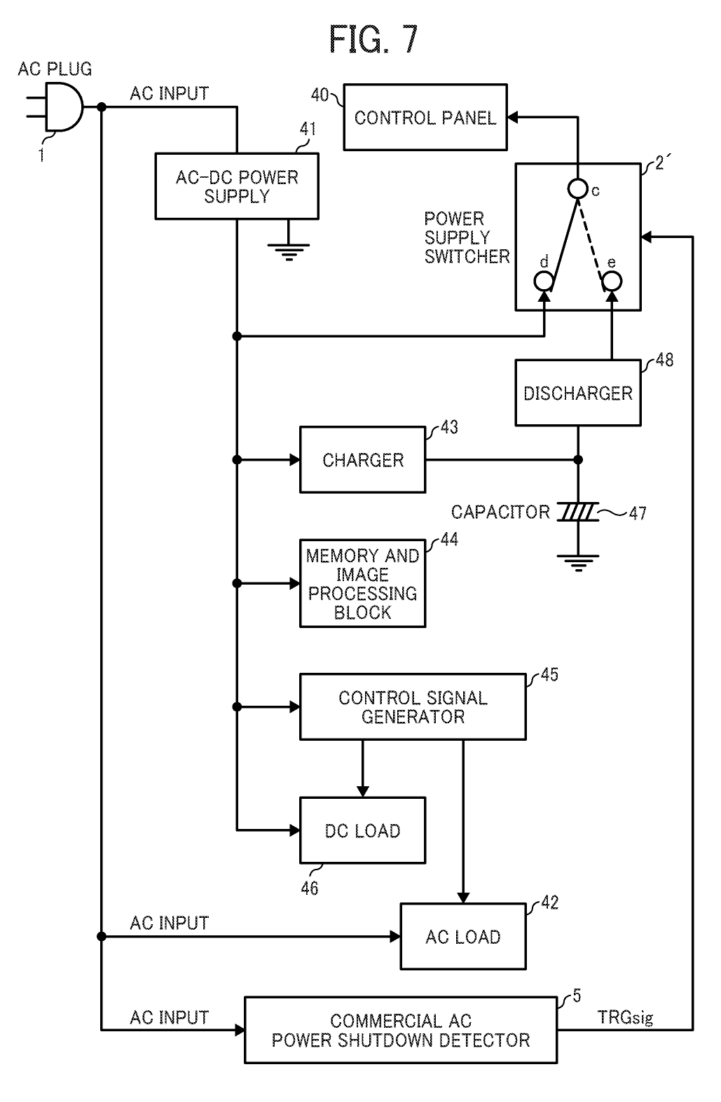

FIG. 7 is a block diagram illustrating an image forming apparatus including the commercial AC power shutdown detecting apparatus in this embodiment. The image forming apparatus includes the backup power supply only for the control panel 40. The AC input from the commercial AC power via the AC plug 1 is supplied to an AC-DC power supply 41, an AC load 42, and the commercial AC power shutdown detecting apparatus 5. The AC load 42 is a load such as a fixing heater and a dehumidification heater etc.

The AC-DC power supply 41 generates various DC voltages from the AC input by the commercial AC power and supplies the DC voltages to the input terminal d that is always closed in the power supply switcher 2, a charger 43, a memory and image processing block 44, a control signal generator 45, and a DC load 46. In FIG. 7, these power supply lines are simplified and illustrated by using one line.

The AC load 42 and the DC load 46 include loads in various apparatuses that construct a document scanner, an image forming unit, a paper feeding unit, and a paper ejection unit, for forming an image.

A capacitor 47 such as a high-capacity capacitor or a secondary battery etc. constructs the backup power supply along with the charger 43 and the discharger 48, and an output terminal of the discharger 48 is connected to the input terminal e that is always closed in the power supply switcher 2.

An output terminal c of the power supply switcher is connected to a power source terminal of the control panel 40. The shutdown detection signal TRG_{sig} output by the commercial AC power shutdown detecting apparatus 5 is input into a control terminal of the power supply switcher 2.

If the commercial AC power is input, the charger 43 receives an input from the AC-DC power supply 41 and charges the capacitor 47 connected to the output side of the charger 43 if the capacitor 47 can afford to be charged (i.e., if the capacitor 47 is not charged fully).

In addition, the AC input from the commercial AC power is supplied to the AC load 42 and the commercial AC power shutdown detecting apparatus 5. Since the commercial AC power shutdown detecting apparatus 5 does not output the shutdown detection signal TRG_{sig}, the power supply switcher 2 is in the normal state with the solid line shown in FIG. 7. Therefore, various DC voltages generated by the AC-DC power supply 41 are supplied to the memory and image processing block 44, the control signal generator 45, and the DC load 46 as well as to the control panel 40 via the power supply switcher 2. The DC load 46 and the AC load 42 are controlled being supplied power by the control signal generated by the control signal generator 45.

When the commercial AC power is shut down, the commercial AC power shutdown detecting apparatus 5 promptly detects the shut down and outputs the shutdown detection signal TRG_{sig}. As a result, the power supply switcher 2 is switched to the state illustrated by the broken line in FIG. 7. Then, the power stored in the capacitor 47 is discharged by the discharger 48 and supplied to the control panel 40 via the terminals e and c of the power supply switcher 2. Consequently, even when the commercial AC power is shut down, it is possible to maintain the function of the control panel 40.

In image forming apparatuses, in some cases, after the commercial AC power is shut down due to the blackout or unplug of the AC plug etc. and recovered subsequently, it is possible to take time to initialize the control panel especially, resulting in inconvenience. However, if the function of the control panel is maintained using the backup power supply as described above, it is not required to initialize the control panel in case the commercial AC power is shut down and recovered subsequently. Therefore, it is possible to make boot-up time of the image forming apparatus just like the normal status, resolving user inconvenience.

Numerous additional modifications and variations are possible in light of the above teachings. It is therefore to be understood that within the scope of the appended claims, the disclosure of the present invention may be practiced otherwise than as specifically described herein. For example, elements and/or features of different illustrative embodiments may be combined with each other and/or substituted for each other within the scope of this disclosure and appended claims.

What is claimed is:

1. A commercial AC power shutdown detecting apparatus, comprising:
a photocoupler including a light emitting element and a light receiving element in a package;
a lighting circuit to flow a pulsating current through the light emitting element of the photocoupler to turn on and off light of the light emitting element, the pulsating current being a full-wave rectified alternate current supplied from a commercial AC power;
a charging-discharging circuit including a capacitor and at least one resistor, the charging-discharging circuit to charge the capacitor using a DC voltage supplied from a DC power supply via the at least one resistor when the light emitting element is turned off, and discharge the capacitor via the light receiving element and the at least one resistor when the light emitting element is turned on; and
a comparing circuit to compare a voltage value between terminals of the capacitor with a predetermined voltage value intermediate between a maximum voltage value between the terminals of the capacitor when the light emitting element repeats turning light on and off and the consistent DC voltage value, and output a shutdown detection signal if the voltage value between the terminals of the capacitor exceeds the predetermined voltage value.

2. A system comprising:
the commercial AC power shutdown detecting apparatus according to claim 1;
a backup power supply;
various loads to which the commercial AC power supplies power; and
a power supply switch to switch a power source from the commercial AC power supply to the backup power supply, to cause the backup power supply to supply power to the various loads if the commercial AC power shutdown detecting apparatus outputs the shutdown detection signal.

3. The system according to claim 2,
wherein the backup power supply includes:
a capacitor;
a charger to charge the capacitor with the power from the commercial AC power; and
a discharger to discharge electrical power stored in the capacity and supply the electrical power via the power supply switch.

4. The system according to claim 2, wherein the system is an image forming apparatus capable of forming an image.

5. A system comprising:
the commercial AC power shutdown detecting apparatus according to claim 1;
a backup power supply;
various loads to which the commercial AC power supplies power; and
a power supply switch to switch a power source from the commercial AC power supply to the backup power supply, to cause the backup power supply to supply power to a specific part if the commercial AC power shutdown detecting apparatus outputs the shutdown detection signal.

6. The system according to claim 5, wherein the system is an image forming apparatus capable of forming an image, and the specific part is a control panel of the image forming apparatus.
